(19) United States
(12) Patent Application Publication
(10) Pub. No.: US 2006/0134423 A1
(43) Pub. Date: Jun. 22, 2006

(54) Composite porous fillers, method of preparation and use

(76) Inventors: Frederic Malet, Rouen (FR); Yves Lermat, Bernay (FR)

Correspondence Address: Thomas F. Roland, Esq.;Arkema Inc., 2000 Market St., Philadelphia, PA, 19103, US

(21) Appl. No.: 11/299,471

(22) Filed: Dec. 12, 2005

(30) Foreign Application Priority Data
Dec. 14, 2004 (FR) FR04.13259

(51) Int. Cl. B32B 5/16; B05D 7/00

(52) U.S. Cl. 428/403; 428/407; 427/221

(57) ABSTRACT

The subject of the invention is a novel method of preparing a composite powder from a porous filler and a thermoplastic. The subject of the invention is also composite porous fillers, especially porous silicas, containing thermoplastics, and their use.

This application claims benefit, under U.S.C. § 119(a) of French National Application Number FR 04.13259, filed Dec. 14, 2004.

### FIELD OF THE INVENTION

The present invention relates to the field of composite porous fillers and particularly to porous silicas containing thermoplastics, to their method of preparation and to their use.

### BACKGROUND OF THE INVENTION

To prepare composite porous fillers, many documents cite methods that describe the addition of a filler (which may be porous) and its dispersion in a thermoplastic. As regards the reverse situation—the absorption of a thermoplastic into a porous filler—mention may be made of U.S. Pat. No. 3,954,678 (DuPont, 1976) which discloses the synthesis of silica gel microcapsules surrounded by a semipermeable skin based on a polymer of the polyamide type, the composite being synthesized by in situ polycondensation of monomers, that is to say via an interfacial polycondensation method.

U.S. Pat. No. 3,421,931 (Rhodiaceta, 1969) discloses the coating of a pulverulent powder with a polyamide by a method involving dissolution followed by precipitation.

EP 857 538 discloses the synthesis of silica-polyamide composites by two methods, one in which the initial step of incorporating the monomers into the silica is carried out via an aqueous or aqueous-alcoholic solution, and the other by dry blending and melting the solid monomers, before in situ polymerization in the porous filler.

There are many drawbacks with these methods, since in general they require working in several steps and/or in a solvent medium. This requires the solvent to be subsequently removed. It is possible to work in a solid medium, but in this case the precursor monomers of the thermoplastics have to be solid at room temperature and capable of being reduced to a powder. This limits the choice of thermoplastics to be used.

Not one of the methods of the prior art makes it possible to obtain a composite powder directly from a thermoplastic and a porous filler.

### SUMMARY OF THE INVENTION

The object of the invention is to propose a novel method of preparing a composite powder from a porous filler and a thermoplastic, comprising the steps of:

supplying the porous filler and the thermoplastic, each being in the form of solid particles; and

stirring and heating the dry blend at a temperature ranging from 20° C. to 300° C., preferably 50° C. to 150° C., above the melting point of the thermoplastic in order to absorb the elastomer in at least part of the pore volume.

In one embodiment, the porous filler is a silica in powder form, the pore volume of which ranges from 0.5 to 5 ml/g, preferably from 0.7 to 2 ml/g, the absorptivity of which, measured according to the DIN ISO 787N standard, ranges from 100 to 400 ml/100 g, preferably from 150 to 300 ml/100 g, and the mean diameter of which lies in the range from 0.5 to 150 microns, preferably from 25 to 50 microns.

In one version, the thermoplastic in the form of granules is chosen from styrene block copolymers, polybutadienes, polyolefins, polyurethanes, polyamide resins, copolyesters, (co)polyamide resins, functionalized or unfunctionalized polyolefins, polyethers, and polydimethylsiloxane-based products.

In one version, the thermoplastic is a polyamide resin or a (co)polyamide resin, the melting point of which lies in the range from 90° C. to 200° C.

In another embodiment, the weight % thermoplastic material/weight % porous filler ratio lies in the range from 5/95 to 80/20, preferably from 10/90 to 60/40.

In a preferred embodiment, the weight % thermoplastic material/weight % porous filler ratio lies in the range from 30/70 to 60/40.

According to one embodiment of the method, the blend is stirred using an anti-agglomeration device. The duration of stirring and heating lies in the range from 30 to 120 minutes.

Another subject of the present invention is a composite powder comprising a porous silica, the pore volume of which ranges from 0.5 to 5 ml/g, preferably from 0.7 to 2 ml/g, the absorptivity of which, measured according to the DIN ISO 787N standard, ranges from 100 to 400 ml/100 g, preferably from 150 to 300 ml/100 g and the mean diameter of which lies in the range from 25 to 50 microns, the said porous silica containing a thermoplastic in at least part of the pore volume.

According to one embodiment of the composite powder, the weight % thermoplastic material/weight % silica ratio lies in the range from 5/95 to 80/20, preferably from 10/90 to 60/40.

In a preferred embodiment, the weight % thermoplastic material/weight % porous filler ratio lies in the range from 30/70 to 60/40.

In one version, the thermoplastic is chosen from styrene block copolymers, polybutadienes, polyolefins, polyurethanes, polyamide resins, copolyesters, (co)polyamide resins, functionalized or unfunctionalized polyolefins, polyethers, and polydimethylsiloxane-based products.

Preferably, the thermoplastic is a polyamide resin or a (co)polyamide resin, the melting point of which lies in the range from 90° C. to 200° C.

The subject of the invention is also the composite powder obtained by the method described above.

Yet another subject of the invention is the use of the composite powder according to the invention as a modifier in paints or cosmetic products, as a carrier of organic substances, or as a support for a chromatography system.

### DETAILED DESCRIPTION OF THE INVENTION

The method of preparing a composite powder according to the invention is carried out in general starting from a porous filler and a thermoplastic.

The first step is to provide the porous filler and the thermoplastic. Preferably, each of the reactants is in the form of solid particles, the dry blend of which is then stirred and heated to a temperature above the melting point of the thermoplastic in order to absorb the elastomer in at least part of the pore volume of the porous filler.

Such a method therefore makes it possible to absorb a thermoplastic in the pores of a porous filler in a single step starting from thermoplastic polymers that are already manufactured. There are many advantages of this method:

easy processing with commercially available raw materials;

no in situ polymerization reactions, which generate bi-products and impurities that would have to be removed; and

reaction in a solid medium, therefore dispensing with the use of a solvent which would have to be removed.

Suitable porous fillers within the context of the invention may include any mineral material in particle form containing an internal pore volume. For example, mention may be made of zeolite-type systems, porous silicas, etc. Most particularly preferred are porous systems, especially porous silicas, whose pore volume ranges from 0.5 to 5 ml/g, preferably from 0.7 to 2 ml/g, whose oil absorptivity, measured according to the DIN ISO 787N standard, ranges from 100 to 400 ml/100 g, preferably from 150 to 300 ml/100 g, and whose mean diameter lies in the range from 0.5 to 150 microns, preferably from 25 to 50 microns.

The thermoplastics that occupy at least part of the pore volume of the composite powders according to the invention may also be thermoplastic elastomers. The thermoplastics used in the invention comprise in general styrene block copolymers, polybutadienes, polyolefins, polyurethanes, polyamide resins, copolyesters, (co)polyamide resins, functionalized or unfunctionalized polyolefins, polyethers, and polydimethylsiloxane-based products.

It will be preferable to use, as thermoplastics, polyamide resins that are copolymers having polyamide blocks and polyether blocks. Copolymers having polyamide blocks and polyether blocks result from the copolycondensation of polyamide blocks having reactive end groups with polyether blocks having reactive end groups, such as, inter alia:

1) polyamide blocks having diamine chain ends with polyoxyalkylene blocks having dicarboxylic chain ends;

2) polyamide blocks having dicarboxylic chain ends with polyoxyalkylene blocks having diamine chain ends, obtained by cyanoethylation and hydrogenation of aliphatic dihydroxylated alpha, omega-polyoxyalkylene blocks called polyetherdiols; and

3) polyamide blocks having dicarboxylic chain ends with polyetherdiols, the products obtained being, in this particular case, polyetheresteramides.

The copolymers of the invention are advantageously of this type.

The polyamide blocks having dicarboxylic chain ends derive, for example, from the condensation of polyamide precursors in the presence of a dicarboxylic acid chain stopper.

The polyamide blocks having diamine chain ends derive, for example, from the condensation of polyamide precursors in the presence of a diamine chain stopper.

The polymers having polyamide blocks and polyether blocks may also include randomly distributed units. These polymers may be prepared by the simultaneous reaction of the polyether with the polyamide block precursors.

For example, it is possible to react a polyetherdiol, polyamide precursors and a diacid chain stopper. What is obtained is a polymer having essentially polyether blocks and polyamide blocks of very variable length, but also the various reactants, having reacted in a random fashion, which are distributed randomly along the polymer chain.

It is also possible to make the polyetherdiamine, polyamide precursors and a diacid chain stopper react. What is obtained is a polymer having essentially polyether blocks and polyamide blocks of very variable length, but also the various reactants, having reacted in a random fashion, are distributed randomly along the polymer chain.

The amount of polyether blocks in these copolymers having polyamide blocks and polyether blocks is advantageously from 10 to 70 wt %, preferably from 35 to 60 wt %, of the copolymer.

The polyetherdiol blocks are either used as such and copolycondensed with polyamide blocks having carboxylic end groups, or they are aminated so as to be converted into polyetherdiamines and condensed with polyamide blocks having carboxylic end groups. They may also be blended with polyamide precursors and a diacid chain stopper in order to make polymers having polyamide blocks and polyether blocks, with units distributed randomly.

The number-average molecular weight of the polyamide sequences lies in the range from 500 to 10 000 and preferably from 500 to 4000, except for the polyamide blocks of the second type. The molecular weight of the polyether sequences lies in the range from 100 to 6000 and preferably from 200 to 3000.

These polymers having polyamide blocks and polyether blocks, whether they derive from the copolycondensation of polyamide and polyether sequences prepared beforehand or from a one-step reaction, have, for example, an intrinsic viscosity of between 0.8 and 2.5 measured in meta-cresol at 25° C. for an initial concentration of 0.8 g/100 ml.

The melting points of the thermoplastics used within the context of the invention lie in general between 80° C. and 275° C., preferably between 90° C. and 200° C.

In general, in the first step of the method, the starting reactants are introduced in a ratio, expressed as weight %, of thermoplastic material/weight % of porous filler that lies in the range from 5/95 to 80/20, preferably from 10/90 to 60/40. The dry blend is then stirred and heated.

Depending on the melting point of the thermoplastic chosen, the blend will be heated in general to a temperature ranging from 100° C. to 300° C., preferably 200° C. to 280° C., above the melting point of the thermoplastic in order to allow the elastomer to be absorbed into at least part of the pore volume. This way the thermoplastic will be made sufficiently fluid to penetrate into at least part of the pore volume of the porous filler.

In one version of the method, the blend is stirred with a device for preventing the formation of agglomerates. This is because, when the weight % of thermoplastic material/weight % porous filler ratio is greater than 30/70, and especially when it is desired to reduce the heating temperature, the formation of agglomerated porous filler particles may be observed at the start of blending. By using a suitable anti-agglomeration tool, the porous filler agglomerates can be broken up and a composite powder obtained in which the final mean particle size remains approximately equivalent to the initial mean particle size.

The subject of the invention is also a composite powder obtained from a porous silica chosen within a mean diameter range from 25 to 50 microns.

The use of this particular porous silica for implementing the method according to the invention makes it possible to reduce the amount of physical agglomeration that occurs at the start of the method, during the step of stirring and heating the blend of solids. This choice of porous silica also makes it possible to obtain a composite powder that incorporates large amounts of thermoplastic, in particular possibly ranging up to 60% by weight of thermoplastic without appreciably modifying the mean particle size of the final composite powder.

The subject of the present invention is also the various uses of the composite powders obtained according to the method described above. They may be used as a modifier in paints or cosmetic products, or else as a carrier for organic substances (medicaments, insecticides), or else as a support for a chromatography system.

### EXAMPLES

The following examples illustrate the present invention without however limiting its scope.

The results of the various trials are summarized in Tables 1 and 2.

### Example 1

The trials were carried out in a large glass tube reactor with a volume of 0.51. An oil bath was regulated to a temperature suitable for the thermoplastic chosen, that is to say at a temperature allowing the thermoplastic to melt and penetrate into the pores of the silica. The reactor was fitted with a large anchor stirrer: outside diameter of the blades: 4.7 cm; height of the blades: 14.5 cm; wall/blade gap: 6 mm. The silica and thermoplastic in powder form were weighed in the reactor and dry-blended. The stirring speed used was up to 300 rpm, or higher. Once the reactor was mounted and supplied with the reactants, it was flushed with nitrogen for 15 minutes before being immersed in the oil bath. The blend was stirred for the time required for the thermoplastic to melt and penetrate into the pores of the porous filler.

Once the reaction had been completed, the powder was collected and screened in order to determine the amount of composite powder with a mean diameter below and above 0.1 mm, which characterizes the degree of physical agglomeration of the particles in the method.

### Example 2

The procedure was as in Example 1, but with a medium-sized anchor stirrer: outside diameter of the blades: 4.7 cm; wall/blade gap: 6 mm; height of the blades: 8 cm, so as to allow the insertion of a counterblade produced by a 2 mm diameter needle placed between the blade and the wall of the glass tube. The needle was held by a septum in a seating at the top of the reactor.

The presence of the needle resulted in the progressive break-up of the grains in the trials where agglomeration of the grains could form.

Table 1 gives the results of the agglomeration and the mean particle size of the composite powders obtained for various initial mean diameters of the porous silica particles and for various amounts of thermoplastics used.

TABLE 1

| Trial No. | | | | |
|---|---|---|---|---|
| 1 | 2 | 3 | 4 | 5 |

| | | | | | |
|---|---|---|---|---|---|
| Silica particle | 25-34 | 25-34 | 25-34 | 35-47 | 20 |
| size (μm) | | | | | |
| % by weight of | 10 | 20 | 40 | 60 | 45 |
| PEBAX* 3533 | | | | | |
| Heating | 280 | 280 | 280 | 250 | 280 |
| temperature | | | | | |
| (° C.) | | | | | |
| Heating/stirring | 120 | 120 | 120 | 120 | 120 |
| time (min) | | | | | |
| Stirring with or | | | | with | |
| without | | | | | |
| counterblade | | | | | |
| Screening: Ø > 0.1 mm | 0.5 | 1 | 6.8 | 10 | 16 |
| (% by | | | | | |
| weight) | | | | | |
| Screening: Ø < 0.1 mm | 99.5 | 99 | 93.3 | 90 | 84 |
| (% by | | | | | |
| weight) | | | | | |
| D50** of the | not | <36 | 36 | 47 | not |
| composite | meas- | | | | meas- |
| (μm) | ured | | | | ured |

*PEBA (polyether-block-amide) resin sold by the Applicant under the name PEBAX ®, having a melting point of 155° C.;
**D50: mean diameter of the composite particles obtained.

This table shows that the degrees of incorporation of thermoplastic, expressed as % by weight, introduced into the blend may vary widely, ranging in particular from 10 to 60% by weight of thermoplastic.

It also shows that the degree of agglomeration, represented by the % by weight of the powder with a mean diameter greater than 0.1 mm, is lower with porous silica particles having an initial mean diameter of greater than 20 microns (trials 1 to 4).

Table 2 gives the results according to the variations in various parameters used in the method described in Examples 1 and 2 above.

TABLE 2

| | Trial No. | | | | | |
|---|---|---|---|---|---|---|
| | 6 | 7 | 8 | 9 | 10 | 11 |
| Silica particle | 32 | 32 | 32 | 32 | 32 | 32 |
| size (μm) | | | | | | |
| % by weight of | 30 | 40 | 40 | 40 | 40 | 40 |
| PLATAMID | | | | | | |
| H106* | | | | | | |
| Heating | 250 | 230 | 250 | 270 | 225 | 225 |
| temperature | | | | | | |
| (° C.) | | | | | | |
| Total reaction | 40 | 60 | 60 | 60 | 70 | 110 |
| time (min) | | | | | | |
| Stirring with or | With- | With- | Without | Without | With | With |
| without | out | out | | | | |
| counterblade | | | | | | |
| Screening: Ø > 0.1 mm | 4.6 | 20 | 20 | 20 | 17 | 12.4 |
| (% by | | | | | | |
| weight) | | | | | | |
| Screening: Ø < 0.1 mm | 95.5 | 75 | 75 | 75 | 83 | 87.6 |
| (% by | | | | | | |
| weight | | | | | | |
| D50** of the | 37 | | | | 41 | 41 |
| composite (μm) | | | | | | |

*(co)polyamide - 6/6, 6/11/12 resin sold by the Applicant under the name PLATAMID ®, having a melting point of 96° C.;
**D50: mean diameter of the composite particles obtained.

This shows that, in trial 6, a 70/30 silica/PEBAX composite is synthesized by simple stirring at 250° C. without a counterblade.

It is feasible to synthesize a 60/40 silica/PEBAX® composite at 225° C. or 230° C., but it is preferable to use a tool for breaking up the agglomerates that form at the start of synthesis (trial 7 compared with trial 10).

In all the trials, the mean particle size distribution hardly changes. This is because the mean diameter D50 passes from 32 microns in the case of the initial silica to 37 and 41 microns for the 30 wt % and 40 wt % PEBAX composites, respectively.

The increase in the blending time and the use of a counterblade reduce the degree of agglomeration characterized by a slight increase in the amount of particles having a diameter of less than 0.1 mm (trial 11 compared with trial 10).

1. A method of preparing a composite powder from a porous filler and a thermoplastic, comprising the steps of:
a) supplying the porous filler and the thermoplastic, each being in the form of solid particles to form a dry blend; and
b) stirring and heating the dry blend at a temperature ranging from 20° C. to 300° C., above the melting point of the thermoplastic in order to absorb the elastomer in at least part of the pore volume.

2. The method according to claim 1 wherein the stirring and heating step (b) occurs at a temperature ranging from 50° C. to 150° C.

3. The method according to claim 1, wherein the porous filler is a silica in powder form, the pore volume of which ranges from 0.5 to 5 ml/g, the absorptivity of which, measured according to the DIN ISO 787N standard, ranges from 100 to 400 ml/100 g, and the mean diameter of which lies in the range from 0.5 to 150 microns.

4. The method according to claim 3, wherein the porous filler is a silica in powder form, the pore volume of which ranges from 0.7 to 2 ml/g, the absorptivity ranges from 150 to 300 ml/100 g, and the mean diameter of which lies in the range from 25 to 50 microns.

5. The method according to claim 1, wherein the thermoplastic in the form of granules is selected from the group consisting of styrene block copolymers, polybutadienes, polyolefins, polyurethanes, polyamide resins, copolyesters, (co)polyamide resins, functionalized or unfunctionalized polyolefins, polyethers, and polydimethylsiloxane-based products.

6. The method according to claim 5, wherein the thermoplastic is a polyamide resin or a (co)polyamide resin, the melting point of which lies in the range from 90° C. to 200° C.

7. The method according to claim 1, wherein the weight percent thermoplastic material/weight percent porous filler ratio lies in the range from 5/95 to 80/20, preferably from 10/90 to 60/40.

8. The method according to claim 7, wherein the weight percent thermoplastic material/weight percent porous filler ratio lies in the range from 10/90 to 60/40.

9. The method according to claim 8, wherein the weight percent thermoplastic material/weight percent porous filler ratio lies in the range from 30/70 to 60/40.

10. The method according to claim 9, wherein the blend is stirred using an anti-agglomeration device.

11. The method according to claim 1, wherein the duration of stirring and heating lies in the range from 30 to 120 minutes.

12. A composite powder comprising a porous silica having a pore volume which ranges from 0.5 to 5 ml/g, the absorptivity of which, measured according to the DIN ISO 787N standard, ranges from 100 to 400 ml/100 g, and the mean diameter of which lies in the range from 25 to 50 microns, the said porous silica containing a thermoplastic in at least part of the pore volume.

13. The composite powder according to claim 12, comprising a porous silica having a pore volume which ranges from 0.7 to 2 ml/g, the absorptivity ranges from 150 to 300 ml/100 g.

14. The composite powder according to claim 12, wherein the weight percent thermoplastic material/weight % silica ratio lies in the range from 5/95 to 80/20, preferably from 10/90 to 60/40.

15. The composite powder according to claim 14, wherein the weight percent thermoplastic material/weight percent silica ratio lies in the range from 10/90 to 60/40.

16. The composite powder according to claim 15, wherein the weight percent thermoplastic material/weight percent porous filler ratio lies in the range from 30/70 to 60/40.

17. The composite powder according to claim 12, wherein the thermoplastic is selected from the group consisting of styrene block copolymers, polybutadienes, polyolefins, polyurethanes, polyamide resins, copolyesters, (co)polyamide resins, functionalized or unfunctionalized polyolefins, polyethers, and polydimethylsiloxane-based products.

18. The composite powder according to claim 17, in which the thermoplastic is a polyamide resin or a (co)polyamide resin, the melting point of which lies in the range from 90° C. to 200° C.

19. The composite powder according to claim 12 comprising a modifier in paints or cosmetic products, a carrier of organic substances, or a support for a chromatography system.
